(19) United States
(12) Patent Application Publication
(10) Pub. No.: US 2024/0366447 A1
(43) Pub. Date: Nov. 7, 2024

(54) Side Rail Locking Mechanism

(71) Applicant: LINET SPOL. S R.O., Slany (CZ)

(72) Inventor: Pavel Coupek, Kladno (CZ)

(73) Assignee: LINET SPOL. S R.O., Slany (CZ)

(21) Appl. No.: 18/573,407

(22) PCT Filed: Jun. 20, 2022
(86) PCT No.: PCT/CZ2022/000029

§ 371 Date: Dec. 21, 2023

(30) Foreign Application Priority Data
Jun. 22, 2021 (CZ) PV 2021-312

(51) Int. Cl. A61G 7/05; A61G 1/04

(52) U.S. Cl. CPC A61G 7/0509; A61G 1/04

(57) ABSTRACT

A locking mechanism of a tube side rail locks all vertical braces of the tube side rail in the raised position. The tube side rail comprises a handle and the vertical braces safely support a patient on a hospital or emergency patient support apparatus.

### TECHNICAL FIELD

The patent application discloses a locking mechanism of a tube side rail for locking of all vertical braces of the tube side rail in the raised position. The tube side rail with a handle and the vertical braces supports safety of a patient on the hospital or emergency patient support apparatuses.

### PRIOR ART

Patient support apparatuses used in medical and nursery facilities or emergency stretchers usually have some type of side rails on each side of the support deck to prevent a patient to fall down from the bed and suffer any serious injury. One type of such collapsible side rails are tube side rails with vertical braces and a handle.

Several types of side rails located lengthwise are used to protect patient against fall from stretchers or hospital beds or to prevent a patient to exit hospital bed. These side rails can be fixed, e.g. conventional side rails, or removable, e.g. protectors, headboards, footboards etc. Removable as well as fixed collapsible side rails enable caregivers to have better access to a patient and also more comfortable maintenance of a support deck of a patient support apparatus.

Majority of standard conventional side rails collapse vertically downwards below a support deck of a patient support apparatus. To secure or lock the side rail in the raised position they may have a lever or arm on the external side of the side rail to unlock a simple locking mechanism. Such lever can have a shape of a latch hook fitting into a locking cut or recess. Other types of generally movable side rails having simple locks are known as previously patented prior art as mentioned below herein.

The collapsible tube side rail disclosed herein comprises plurality of braces or arms, the same as collapsible side rail disclosed in the U.S. Pat. No. 5,187,824. The side rail in the U.S. Pat. No. 5,187,824 comprises a locking system in the form of blocking mechanism shaped as a latch hook which is located only on one arm of the tube side rail and which fits into a latch of a locking lever as stated on the FIG. 9 of this patent. The figure shows that this type of side rail comprises a very simple locking mechanism which is entirely inconvenient regarding patient safety. In case a spring of the latch of the locking lever releases or ruptures, there is a high risk of spontaneous fall or collapse of the tube side rail which consequently causes a risk of fall of a patient from the patient support apparatus. In addition, a caregiver may forget to lock the side rail and because there is no other securing element in this type of tube side rail eliminating risk of fall a patient is again endangered with possible spontaneous collapse of the side rail and consequent fall of such patient from the patient support apparatus. Despite low production costs such tube side rail mechanism and solution is easily expendable, not sufficiently safe and not acceptable with respect to hygiene of medical support apparatuses as impurities may remain easily in this mechanism.

Also other existing systems and mechanisms relating to tube side rails with vertical braces or arms are, despite being simple and cheap, insufficiently safe with respect to locking the side rail in the raised position, or they do not follow a requirement for simplicity to use and strict hygienic rules in medical and nursery facilities. More complex system uses more complex mechanisms inside which dust filing or dried liquids remain, and due to construction folding and using of springs inside they are frequently damaged.

### SUMMARY OF THE INVENTION

The above mentioned substantial insufficiencies of the existing known technical solutions are solved by presented technical solution for a tube side rail of a patient support apparatus comprising vertical braces (or arms) and compact central locking mechanism of vertical braces to lock the tube side rail. A patient support apparatus comprises an undercarriage, a lifting mechanism, a support desk, a frame of the support deck and a tube side rail having a handle and vertical braces which is a part of the frame of the support deck.

This type of collapsible tube side rail having a handle and vertical braces is predominantly used on stretchers or patient support apparatuses for fast emergency transport of a patient or short term care. The tube side rail serves for protection of a patient on the patient support apparatus to prevent the patient from a fall or exiting such patient support apparatus.

The type of the tube side rail mentioned above may be also removable, however, in majority of cases such tube side rails is a part of a frame of the support deck and collapses downwardly alongside the support deck so that the upper part of upper edge of a handle of the tube side rail was located as much as possible under the level of mattresses and creates thus a continuous plane with the support deck. This type of tube side rail may be used also on headboard and footboard part of a patient support apparatus, however due to usually short length of such headboards and footboards are not used therein. Present types of tube side rails with vertical braces have one essential disadvantage which is insufficient locking of side rail against spontaneous or sudden collapsing. Should any tube side rails have better locking system than of one vertical brace only, such locking is too complex, engages too large space, is prone to be filled with impurities, and is often costly to be produced.

The tube side rail disclosed herein by us comprises a handle of the side rail comprising openings or perforations for location of removable remote control unit or pendent additional control unit with cable. Additionally, the handle may comprise a ball protractor or another type of a protractor according to type of a patient support apparatus. Plurality of vertical braces are attached to the handle. The vertical braces may be shaped at will, preferably shaped such that they cover as less area under the support deck as possible, or they do not protrude outside of the patient support apparatus. In the preferred embodiment, the shape of the vertical braces follows conditions not to obstruct when collapsing the tube side rail down, and to create as much space as possible for a patient when being raised up. Vertical braces are fixed at the upper end of the braces to the bottom side of the handle of the tube side rail by means of pivots, and at the bottom end of the braces they are attached to a bottom edge of a longitudinal frame of a support deck, i.e. frame side bar, by means of lock control elements. In another embodiment, the vertical braces can be at their bottom end attached to the bottom edge of a longitudinal frame of a support deck, i.e. frame side bar, by means of lock control elements with pins that are not visible. In another embodiment, the vertical braces can be fixed on the side of the longitudinal frame of a support deck, i.e. frame side bar.

In another embodiment, the lock control elements create a part of the vertical braces, wherein the lock control elements are located inside the longitudinal frame of a support deck, i.e. frame side bar, and the vertical brace is located on the external side (outside) of the longitudinal frame of a support deck, i.e. frame side bar, or bottom side of the longitudinal frame of a support deck, i.e. frame side bar. The vertical brace is, in such case, articulated coupled to lock control element. Such articulating coupling may be in form of an articulating support or a screw support. Lock control elements operate as self-locking mechanism, which lock the vertical braces in the upright raised position. The lock control element enables pivotable movement of the vertical brace using an inner pin by which the vertical brace is coupled to the lock control element—this enables movement of the tube side rail from retracted position to the upright raised position, and upside down, from the upright raised position into the retracted position. The inner part of the lock control element secures upright position of the subjected brace and has a function of a lock to lock the brace in the upright raised position. The lock control element comprises an opening which creates a stop for a latch of a central locking mechanism of all vertical braces at one time, and in parallel, each lock control element is attached to a rod comprising at least one latch by means of a protrusion, screw, rivet, pin, or any other coupling element. Preferably, there are just as many latches as lock control elements or vertical braces are.

The central locking mechanism comprises a control lever which is attached to a longitudinal frame of a support deck, i.e. frame side bar, by means of a locking element. The locking element of the control lever is located inside the longitudinal frame of a support deck, i.e. frame side bar, and is coupled also to a rod of the central locking mechanism. The rod comprises at least one latch, or a group of latches, at one end, and preferably the rod is put on a protrusion of the locking element. In another embodiment, the rod can be coupled using a rivet, a screw, a pin, or any other coupling element with sliding part which is located inside the locking element of the control lever. The control lever is coupled to the locking element of the control lever at one end and movement of the control lever is transmitted via sliding part inside the locking element of the control lever onto the rod. The control lever moves the rod by means of sliding part, which is inside the locking element of the longitudinal frame of a support deck, i.e. frame side bar, which the rod is attached to on the opposite side of the locking element of the control lever. The rod is coupled to all lock control elements by means of pins, rivets, or sliding protrusions which are also coupled to the rod which comprises plurality of latches fitting into the cuts, or plurality of latches in the lock control elements of upright vertical braces. The entire mechanism is released by control lever of the locking mechanism which releases all vertical braces by means of the rod.

Should the control lever of the locking mechanism be upwards, the rod moves and releases latches from the lock control elements by which all vertical braces are released. Consequently, a caregiver can control the side rail and collapse it toward the support deck.

Should the control lever of the locking mechanism be downwards, it means that all lock control elements are locked due to movement of the rod in the opposite direction. Vertical braces are locked if the tube side rail is in the upright raised position and upon turning the control lever downwards all latches of lock control elements fit into the stops of lock control elements of the central locking mechanism by means of the rod the locking position. All vertical braces of the tube side rail are then locked by simple easy operation at once.

Preferably, all vertical braces comprise lock control elements to lock all vertical braces at once, which, in addition, reinforce the side rail and avoid breaking of the side rail or sudden unlocking of the side rail. The disclosed tube side rail is safer and more rigid. Location of the entire locking mechanism inside the longitudinal frame of a support deck, i.e. frame side bar, increases hygienic conditions, and size and simplicity of this mechanism decreases production costs. Such convenient location of the locking mechanism additionally guarantees faultless operation compering to other side rail mechanisms.

### LIST OF DRAWINGS

FIG. 1 shows a tube side rail from external view in the upright raised position and a control lever attached to a longitudinal frame of a support deck, i.e. frame side bar.

FIG. 2 shows a tube side rail from external view in the upright raised position and a cross-section of a longitudinal frame of a support deck, i.e. frame side bar.

FIG. 3 shows a tube side rail from external view in the upright raised position and a cross-section of a longitudinal frame of a support deck, i.e. frame side bar.

FIG. 4 shows a tube side rail in the collapsed, retracted position and a cross-section of a longitudinal frame of a support deck, i.e. frame side bar.

FIG. 5 shows a detailed view of attachment of a bottom part of a vertical brace and a detailed view of a cross-section of a longitudinal frame of a support deck, i.e. frame side bar.

FIG. 6 shows a detailed view of lock control elements of vertical braces and a locking element of a control lever.

### LIST OF REFERENCES

1) Tube side rail
2) Handle (of a tube side rail)
3) Vertical brace (of a tube side rail)
   3a) upper end of a vertical brace
   3b) bottom end of a vertical brace
4) Longitudinal frame of a support deck (frame side bar)
5) Control lever (of a locking mechanism)
6) Pivot (of upper attachment of vertical brace to a handle)
7) Lock control element
8) Locking element (of a control lever)
9) Rod
10) Pin of latch attachment
11) Latch
12) Stop
13) Sliding element

### EXEMPLARY EMBODIMENTS OF THE INVENTION

Disclosed technical solution describes a central locking mechanism of a tube side rail with vertical braces, which locks all vertical braces 3 and prevents collapsing of a tube side rail 1 into the retracted, collapsed position. Central locking mechanism of the tube side rail provides better firmness and stability of the tube side rail 1.

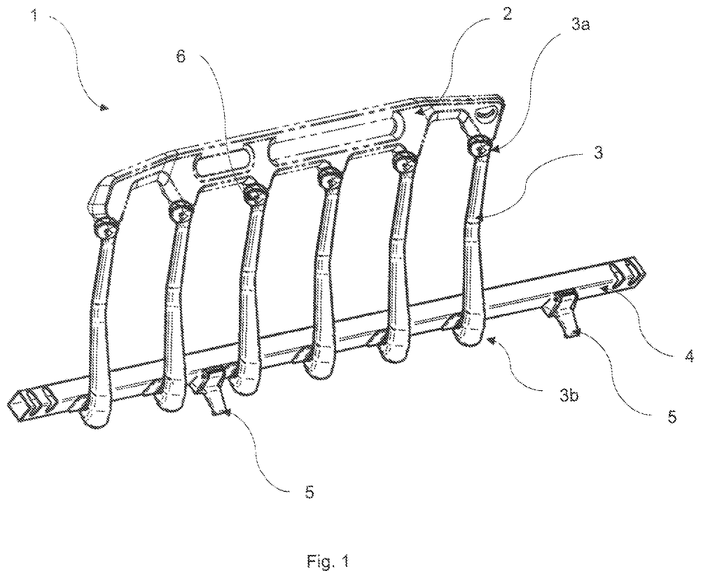

FIG. 1 shows a tube side rail 1 from the external view in the upright raised position. The tube side rail 1 comprises a handle 2, which comprises an opening for gripping and handling, optionally such opening can be used for fixing a wireless remote controller of a patient support apparatus. The handle 2 may also comprise a ball protractor or any other type of protractor. The handle 2 comprises six vertical braces 3 on the bottom side of the handle 2, preferably the tube side rail 1 comprises plurality of such vertical braces 3. Each vertical brace 3 comprises an upper end of a vertical brace 3a and a bottom end of a vertical brace 3b, wherein the upper ends of the vertical braces 3a are coupled to the handle 2 pivotably using pivots 6 on the bottom side of the handle 2. The bottom ends of vertical braces 3b are coupled by lock control elements 7 (not shown in this figure) which are located in the longitudinal frame of a support deck 4. The FIG. 1 also shows a control lever 5 of the locking mechanism, which is attached to the longitudinal frame of a support deck 4 using a locking element 8 of the control lever (not shown in this figure). Preferably, two control levers 5 are used on each side of the support deck of the patient support apparatus, however only one control lever 5 can be used sufficiently. The control lever 5 unlocks the central locking mechanism. In case a caregiver pushes the control lever 5 upwards, the lock control elements 7 (not shown in this figure) are released, i.e. unlocked. Consequently, a caregiver may collapse the tube side rail 1 into the collapsed, retracted position using the handle 2.

The handle 2, vertical braces 3 and the control lever 5 may be produced from different types of material such as metal, plastics, or metal alloys or plastic alloys, wood etc. In the disclosed embodiment these parts are produced from plastic material. The longitudinal frame of a support deck 4 and pivots 5 of upper attachment of vertical braces 3 are preferably produced from metal materials or metal alloys.

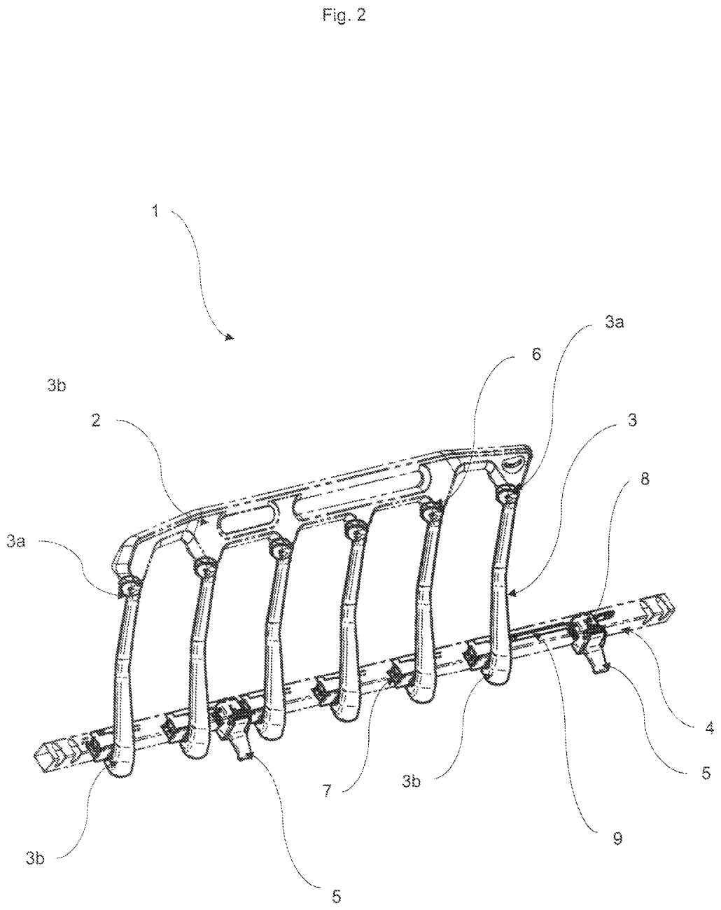

FIG. 2 shows a tube side rail 1 comprising a handle 2 and plurality of vertical braces 3 coupled pivotably to the handle 2 at upper end of vertical braces 3a by pivots 6. The bottom ends of vertical braces 3b are coupled by lock control elements 7 located in the longitudinal frame of a support deck 4. Additionally, the FIG. 2 shows a cross-section of the longitudinal frame of a support deck 4 which obviously shows that the vertical braces 3 are coupled to lock control elements 7 and locking elements 8 of two control levers 5 by a rod 9. Lock control elements 7 and locking elements 8 of both control levers 5 are located in the longitudinal frame of a support deck 4, the same as the rod 9, which goes through, and which comprises latches 11 (not shown in this figure) on its internal side.

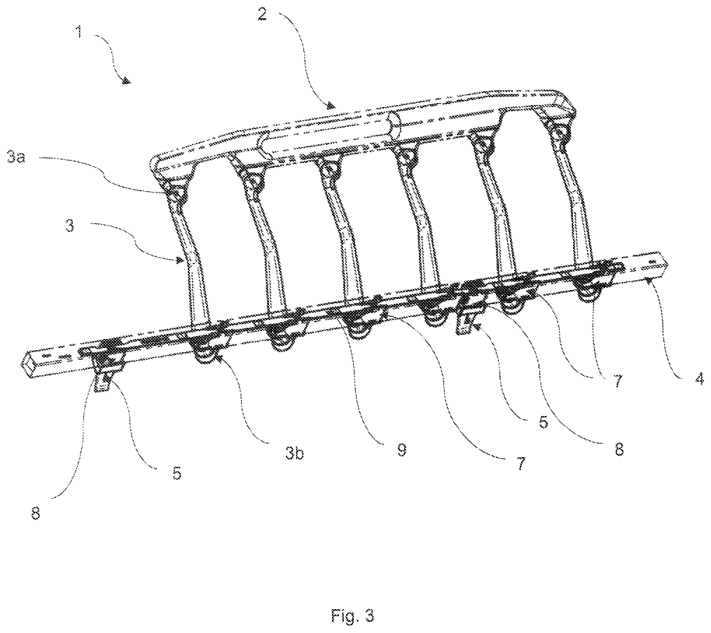

FIG. 3 shows a tube side rail 1 from internal view of a patient support apparatus, and internal view of a handle 2 and vertical braces 3 coupled to the external side of a longitudinal frame of a support deck, which is shown herein including the internal hollow space. The FIG. 3 shows that the longitudinal frame of a support deck 4 comprises plurality of lock control elements 7 of vertical braces 3 and at least one locking element 8 of control lever 5, wherein preferably, two locking elements 8 and two control levers 5 of the central locking mechanism are used. The disclosed cross-section of the longitudinal frame of a support deck 4 shows a rod 9, which is in contact with all shown lock control elements 7 and both locking elements 8 of control levers 5. In another embodiment, plurality of lock control elements 7 as well as locking elements 8 of control lever 5 can be used, however at least one locking element 8 of control lever 5 through which the rod 9 goes inside the longitudinal frame of a support deck 4 is needed. As shown in previous figures, all vertical braces 3 of the tube side rail 1 are in upright raised position and the control lever 5 is in downward position below the longitudinal frame of a support deck 4, which means that the tube side rail 1 is locked and all vertical braces 3 are locked by latches 11 of the rod 9, which are fitted in the stops 1 (not shown in this figure). Due to lock control elements 7 and coupling with the rod 9 it is possible to lock all vertical braces 3 very easily only by raising the handle 2 upwards because vertical braces 3 are coupled to lock control elements 7, by which vertical braces 3 are in parallel coupled to the rod 9, which is the same coupled to locking element 8 of the control lever 5. When raising the tube side rail 1 upwards using the handle 2 all vertical braces 3 are locked at once, at the same moment.

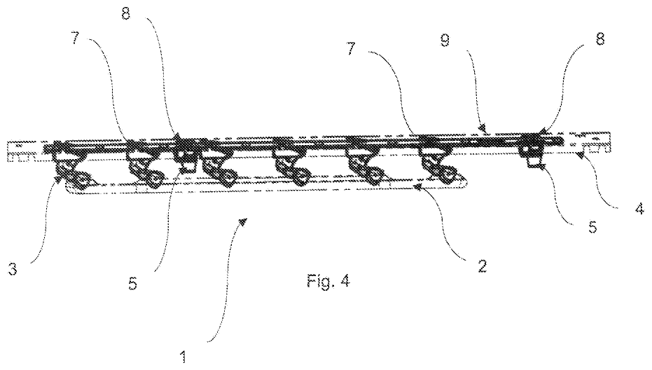

FIG. 4 shows a tube side rail 1 where a handle 2 and vertical braces 3 are in retracted position alongside a longitudinal frame of a support deck 4, wherein the FIG. 4 shows internal view from the patient support apparatus. This FIG. 4 shows that a 9 couples all lock control elements 7 and two locking elements 8 to control levers 5 of the central locking mechanism. The FIG. 4 shows obviously that the vertical braces 3 are unlocked. The control lever 5 of the locking mechanism is in upwards position in relation to longitudinal frame of a support deck 4 and is visible from the side view. Contrary to previous figures, it is obvious that when raising the control lever 5 upwards in relation to the longitudinal frame of a support deck 4 the rod 9 moves by using locking element 8 of control lever 5 so that lock control elements 7 of vertical braces 3 could be unlocked. Unlocking moves all latches 11 of rod 9 out of lock control elements 7 and consequently, a caregiver may retract the tube side rail 1 downwards alongside the support deck of the patient support apparatus.

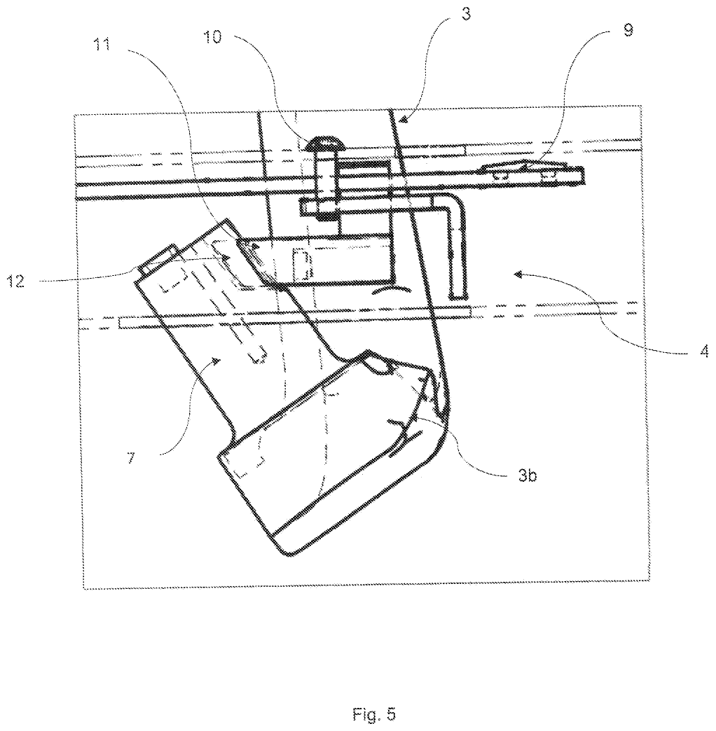

FIG. 5 shows a detail of a bottom end of a vertical brace 3b, which is attached to a lock control element 7 which is located inside a longitudinal frame of a support deck 4. The FIG. 5 shows that lock control element 7 comprises a recess of a stop 12, opposite to which a latch 11 is visible. The latch 11 is coupled to a rod 9 inside the longitudinal frame of a support deck 4 by a pin 10 of latch attachment. Based on this figure, and also the previous disclosed figures it is obvious that a latch 11 is located opposite to each lock control element 7, the latch 11 being coupled to the rod 9 by the pin 10 of latch attachment. In another embodiment, the rod 9 may comprise latches 11, which are profiled directly on the rod 9. In other embodiment, latches 11 can be inserted in the 9 and thus couple the rod 9 to lock control element 7. In addition, the rod 9 is coupled to locking element 8, which is controlled by control lever 5. By pulling the latch 11 away the recess of the stop 12 is released by which the lock control element 7 is released and this enables a caregiver to collapse the tube side rail 1 by handle 2 downwards alongside the support deck of the patient support apparatus.

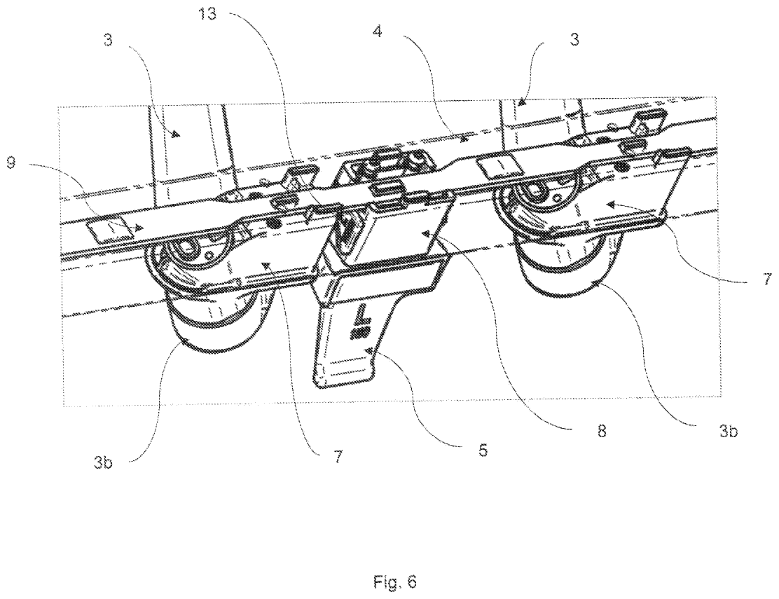

The FIG. 6 shows a detail of attachment of two random vertical braces 3 to a longitudinal frame of a support deck 4 in the cross-section view. Vertical braces 3 are coupled to a lock control element 7 at a bottom end of a vertical braces 3b. A control lever 5 is a part of a locking element 8. The cross-section of the longitudinal frame of a support deck 4 also shows that a rod 9 is coupled to lock control elements 7 and locking element 8 of the control lever 5. The locking element 8 of the control lever 5 is coupled to a sliding element 13, which is coupled to the rod 9, by which the locking element 8 moves and controls the rod 9 located inside the longitudinal frame of a support deck 4. The rod 9 is also coupled to all lock control elements 7. Top view of rod 9 in the longitudinal frame of a support deck 4 shows fixing parts of a latch 11, which can be pins, rivets, or other types of fixing components. Latches 11 and locking element 8 are fixed to the rod 9 on the opposite bottom side of the rod 9 in the inner space of the lock control elements 7 via fixing part of the sliding element 13. FIG. 6 shows where the rod 9 of the central locking mechanism is led through.

The control lever 5 of the locking element 8 is pushed downwards below the longitudinal frame of a support deck 4 and vertical braces 3 are in the upright raised position which means that the central locking mechanism is locked. The control lever 5 is downward and the rod 9 moves to that the latches 11 could fit in the cuts in the lock control elements 7 into the stops 12 (not shown in this figure). The rod 9 is coupled to a locking element 8 of the control lever 5 by means of fixing part so that the control lever 5 could move the rod 9 by means of sliding element 13 lengthwise in the longitudinal frame of a support deck 4 from one side to another. When the control lever 5 is downwards, the locking element 8 of the control lever 5 moves the rod 9 so that the latches 11 (not shown in this figure) fit into the cut of stop 12 in the lock control elements 7 of the vertical braces 3 and enable to lock the vertical braces 3 in the upright raised position. Locking is done also automatically when raising up the handle 2 by raising the handle 2 up the vertical braces 3 which are coupled to lock control elements 7 being attached to the rod 9 turn. The rod 9 changes position of latches 11 of the rod 9 in the lock control elements 7 automatically upon changing of position of the tube side rail 1 from retracted into the upright raised position, also the control lever § is moved to the locked position. In opposite case, when the control lever 5 is pushed upward in relation to the handle 2 of the tube side rail 1 the rod 9 changes position by means of sliding element 13, which transmits movement of the control lever 5 to the rod 9 to the opposite side in the longitudinal frame of a support deck 4 towards from the stops 12. by which locking element 8 is unlocked and also all vertical braces 3 are unlocked as well. This position is not shown.

1. A central locking mechanism of a side rail, the central locking mechanism comprising a handle, a plurality of vertical braces each having a bottom end coupled or articulation to a lock control element comprising a stop inside a longitudinal frame of a support deck, wherein a rod goes through the inside of the longitudinal frame of the support deck, the rod comprising a plurality of latches, wherein each one of the latches is coupled to the lock control element and at least one of the latches is coupled to a locking element and a sliding element of a control lever, which is located on at least one end of the longitudinal frame of the support deck.

2. (canceled)

3. The central locking mechanism according to claim 1, wherein the longitudinal frame of the support deck comprises at least one of the locking elements of the control lever, which is made of plastics or metal alloys.

4. The central locking mechanism according to claim 1, wherein the bottom end of least one of the vertical braces is coupled inside the longitudinal frame of the support deck to the lock control element on a bottom side of the longitudinal frame of the support deck.

5. A central locking mechanism of a side rail, the central locking mechanism comprises a handle, a plurality of vertical braces each having a bottom end coupled to a longitudinal frame of a support deck on a bottom side of the longitudinal frame of the support deck and to plurality of lock control elements and to plurality of stops through which a rod comprising at least one latch goes through, wherein the rod is coupled to at least one locking element and a sliding element of a control lever, wherein the control lever is located outside the longitudinal frame of the support deck.

6. The central locking mechanism according to claim 1, wherein the handle, the vertical braces and the control lever of the locking mechanism are located outside the longitudinal frame of the support deck.

7. The central locking mechanism according to claim 1, wherein the lock control elements, the rod and at least one of the locking elements are located outside of the longitudinal frame of the support deck.
